(19) United States
(12) Patent Application Publication
(10) Pub. No.: US 2026/0310726 A1
(43) Pub. Date: Oct. 8, 2026

(54) IDENTIFYING SUB-GRAPHS FOR GENERATING INFORMATION REQUESTS

(71) Applicant: Dell Products L.P., Round Rock, TX (US)

(72) Inventors: XIAOCHEN CHEN, Shanghai (CN); ZIJIA WANG, London (GB); SCOTT E. JOYCE, Foxboro, MA (US); NING LI, Shanghai (CN)

(21) Appl. No.: 19/098,596

(22) Filed: Apr. 2, 2025

(51) Int. Cl. G06F 16/901; G06F 16/2452

(52) U.S. Cl. CPC G06F 16/9024; G06F 16/24526

(57) ABSTRACT

Methods and systems for providing desired computer implemented services using data stored in data sources of a distributed system are disclosed. The desired computer implemented services may be provided by identifying sub-graphs for generating information requests. A sub-graph of the sub-graphs may be identified by generating customized embeddings based on (i) a generalized graph data structure of the data sources and/or (ii) embeddings based on (a) words of a request template for a data request and/or (b) attention scores that include measures of relative importance between the words. The sub-graph may be used with the request template to generate an information request that is processable by information extraction frameworks. From processing the information request, information may be obtained that is used to facilitate the desired computer implemented services.

### FIELD

Embodiments disclosed herein relate generally to providing desired computer implemented services using data stored in data sources of a distributed system. More particularly, embodiments disclosed herein relate to identifying sub-graphs for generating information requests.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2C show data flow diagrams illustrating operation of a system in accordance with an embodiment.

FIGS. 3A-3B show flow diagrams illustrating at least one method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to providing desired computer implemented services using data stored in data sources of a distributed system. The desired computer implemented services may be provided by (i) receiving a data request and/or (ii) identifying a sub-graph of a customized graph data structure that is used to generate an information request.

The data request may include a request, by an entity (e.g., (i) a user, (ii) an administrator, and/or (iii) any other stakeholder of the distributed system), for information from the data sources of the distributed system. The customized graph data structure may be based on customized embeddings. The customized embeddings may be generated using (i) generalized embeddings of a generalized graph data structure of the distributed system and/or (ii) embeddings that include (a) token embeddings of a request template and/or (b) attention scores between the token embeddings. The token embeddings may be generated from words of a request template that (i) includes (a) statements, (b) clauses, and/or (c) placeholders and/or (ii) is not processable by information extraction frameworks.

The sub-graph and/or the data request may be used to identify data source identifiers of the data sources of the distributed system. Upon the identification, the placeholders may be replaced with the data source identifiers to generate an information request for the data. The information request may be processable by the information extraction frameworks.

Upon processing, by the information extraction frameworks, of the information request, the information may be obtained. The information may be used to facilitate a provisioning of the desired computer implemented services by the distributed system.

In an embodiment, a method for providing desired computer implemented services using data stored in data sources of a distributed system is disclosed. The method may include: (i) obtaining a data request from an entity, the data request being serviceable using a portion of the data stores in data sources, (ii) obtaining, based on the data request and using a request template corresponding to the data request, embeddings for tokens derived from the request template, the embeddings being based, at least in part, on relative importance of the tokens, the relative importance of the tokens being derived from an attention identification algorithm, (iii) identifying, using the embeddings, a sub-graph of a customized graph data structure, the customized graph data structure being based on at least (a) a generalized graph data structure that is based on the data sources, and/or (b) the embeddings, (iv) obtaining, using the sub-graph and the request template, an information request is compatible with information extraction frameworks for the data sources, (v) obtaining, using the information request, the portion of the data, and/or (vi) using the portion of the data to facilitate provisioning of at least the portion of the desired computer implemented services.

The request template may include a query template that comprises prototype clauses having placeholders for input therein, the prototype clauses being runnable clauses after replacement of the placeholders with the input.

Obtaining the information request may include (i) identifying, using the data request and the sub-graph, data source identifiers related to the data request using the data sources of the sub-graph, and/or (ii) generating, using the data source identifiers and the request template, the information request by replacing at least one placeholder of the placeholders with at least one data source identifier of the data source identifiers.

The tokens may include clauses from the request template.

The tokens may be based on a tokenization schema that defines a division of the request template based on the clauses into the tokens.

Obtaining the embeddings may include (i) generating the embeddings for the tokens, the embeddings comprising first numerical representations of the tokens that are not initially based on the relative importance of the tokens, (ii) computing, using the attention identification algorithm, first attention scores between a first token of the tokens and a second token of the tokens in first statement of the clauses of the request template, (iii) computing, using the attention identification algorithm, second attention scores between the first token of the tokens in the first statement and a third token of the tokens in a second statement of the request template, (iv) generating third attention scores that are based on the first attention scores and the second attention scores by performing at least one mathematical operation using the first attention scores and the second attention scores, and/or (v) updating, using the third attention scores, the embeddings comprising second numerical representations that are based, at least in part, on the relative importance of the tokens and the first numerical representations.

The generalized graph data structure may include nodes corresponding to the data sources and edges between the nodes corresponding to relationships between the nodes.

The information extraction frameworks may include database architectures that are adapted to provide information based on the information request, the database architectures having an execution engine that is adapted to interpret, at least, clauses from the information request and provide information based on the interpretation.

Identifying the sub-graph may include (i) identifying the generalized graph data structure that is based on at least one data source related to the data request, (ii) obtaining generalized embeddings from first nodes and first edges of the generalized graph data structure, (iii) updating, using the embeddings, the generalized embeddings to generate customized embeddings; and/or (iv) identifying, using the customized embeddings, the sub-graph.

The information request may include a query usable to obtain the portion of the data.

Identifying the sub-graph may further include performing similarity computations between the customized embeddings and the embeddings to obtain second nodes and second edges of the customized graph data structure.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

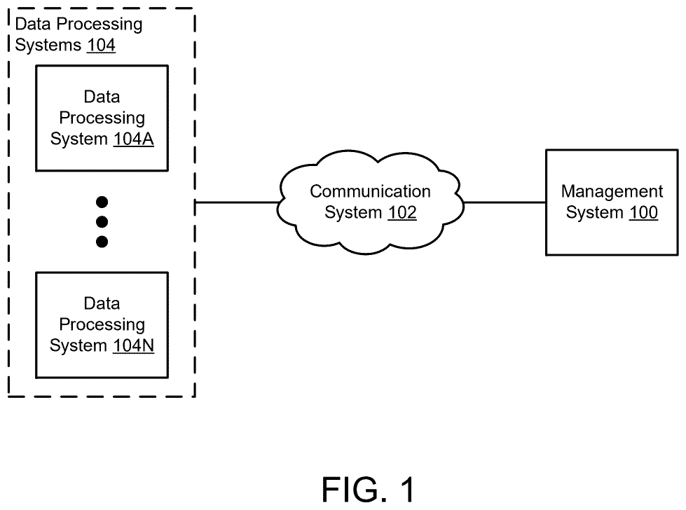

Turning to FIG. 1, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, a data request may be performed by an entity of the distributed system. The entity may include (i) a user, (ii) an administrator, and/or (iii) any other stakeholder of the distributed system. Information of the data request may include (i) performance data of the distributed system, (ii) traffic data of the distributed system, (iii) inventory data of items tracked by software of the distributed system, (iv) sales statistics in a database of the distributed system, etc. The data request may be performed by (i) transmitting the data request to the distributed system, (ii) retrieving, based on any parameter of the data request and/or by the distributed system, the information from software, databases, repositories, etc. of the distributed system, and/or (iii) transmitting, by the distributed system, the information to the entity.

However, the information, which has been retrieved by the distributed system, may not include (i) data, (ii) metadata, (iii) statistics, (iv) annotations, etc. that is relevant to at least one requirement and/or activity of the entity on the distributed system. As a result, provisioning, using the information and/or by the entity, of computer implemented services may be impacted.

In general, embodiments disclosed here relate to systems and methods for providing desired computer implemented services using data stored in data of a distributed system. The method may include (i) obtaining a data request from an entity, the data request being serviceable using a portion of the data stores in data sources, (ii) obtaining, based on the data request, using a request template corresponding to the data request, embeddings for tokens derived from the request template, the embeddings being based, at least in part, on relative importance of the tokens, the relative importance of the tokens being derived from an attention identification algorithm, (iii) identifying, using the embeddings, a sub-graph of a customized graph data structure, the customized graph data structure being based on at least, (a) a generalized graph data structure that is based on the data sources and/or (b) the embeddings, (iv) obtaining, using the sub-graph and the request template, an information request is compatible with information extraction frameworks for the data sources, (v) obtaining, using the information request, the portion of the data, and/or (vi) using the portion of the data to facilitate provisioning of at least the portion of the desired computer implemented services.

The data request may be obtained by receiving, by the distributed system and/or from the entity, the data request for information. The entity may include (i) a user, (ii) an administrator, and/or (iii) any other stakeholder of the distributed system. The information may include (i) performance data of the distributed system, (ii) traffic data of the distributed system, (iii) inventory data of items tracked by software of the distributed system, (iv) sales statistics in a database of the distributed system, etc.

The embeddings may be obtained by updating (i) generating, using a word embedding model, token embeddings for tokens of a request template that is related to the data request and/or (ii) updating, using a first machine learning algorithm, the token embeddings based on attention scores of the tokens to generate the embeddings. The tokens may include words and/or symbols in the request template. The tokens may be based on a tokenization schema that includes definitions for the words and/or the symbols of the information extraction frameworks. Examples of the information extraction frameworks may include (i) Structured Query Language (SQL), (ii) NoSQL, (iii) ORM (Object Related Mapping) Frameworks, (iv) Apache Hive, (v) ELK (Elasticsearch, Logstash, Kibana) Search, etc. The token embeddings may be generated by ingesting the tokens in the word embedding model (e.g., (i) Word2Vec, (ii) GloVe (Global Vectors), (iii) BERT (Bidirectional Encoder Representation Transformers), and/or (iv) any other transformer model) to transform the tokens into the initial embeddings.

The token embeddings may be updated, using the first machine learning algorithm, by (i) generating the attention scores of the tokens and/or (ii) combining the attention scores with the token embeddings to generate the embeddings. The first machine learning model may be adapted to recognize relationships between the tokens. The attention scores of the tokens may be generated by computing the attention scores of at least two initial embeddings of the tokens. The attention scores may include (i) at least one first attention score between a first token embedding and/or a second token embedding within a single statement of the request template and/or (ii) at least one second attention score between the first token in a first statement and/or a third token in a second statement. The attention scores may be combined with the token embeddings using any combination method (e.g., (i) vector addition, (ii) vector subtraction, (iii) cross product, (iv) element-wise multiplication, (v) concatenation, and/or (vi) any other combination method).

The sub-graph may be identified by (i) identifying a generalized graph data structure that is based on at least one data source related to the data request, (ii) obtaining generalized embeddings of the generalized graph data structure, (iii) updating, using the embeddings, the generalized embeddings to generate customized embeddings, and/or (iv) identifying, using the customized embeddings, the sub-graph. The generalized embeddings may be (i) included in the nodes and/or edges of the generalized graph data structure and/or (ii) derived from the generalized graph data structure. The generalized embeddings may be derived, for each node, by aggregating and/or updating the generalized embeddings based on neighboring nodes. The generalized embeddings may be updated, using a second trained machine learning model, by (i) generating messages based on a first at least one neighboring embedding of the generalized embeddings and/or a second at least one neighboring embedding of the embeddings, (ii) updating a generalized embedding based on the messages to generate a customized embedding, and/or (iii) repeating the previous two steps for all other generalized embeddings to generate the customized embeddings. The messages may include (i) framework statements, (ii) data source attributes (e.g., (a) data source names, (b) fields, (c) column names, and/or (d) any other data source attribute), (iii) first relationships between data sources, (iv) second relationships within data sources, etc. The second trained machine learning model may include a graph neural network (e.g., (a) a graph convolution network, (b) a graph attention network, (c) message passing neural network, (d) graph recurrent neural network, and/or (e) any other graph neural network) that is adapted to update the generalized embeddings to generate the customized embeddings.

The information request may be obtained by (i) identifying data source identifiers using the sub-graph and/or related to the data request and/or (ii) generating the information request using the data source identifiers. The information request may be generating by replacing the placeholders with the data source identifiers.

The portion of the data may be obtained, using the information request, by transmitting the information request to the information extraction frameworks to (i) filter, (ii) prioritize, and/or (iii) retrieve the information. The information may include relevant data for use in the provisioning of the desired computer implemented services.

The portion of the data may be used to facilitate provisioning at least the portion of the desired computer implemented services by (i) facilitating performance of optimization actions based on, for example, performance metrics, (ii) adding security patches and/or configurations based on vulnerabilities and/or threat patterns, (iii) adding, modifying, and/or removing access rights based on roles and/or historical usage, (iv) facilitating the performance of incident response actions based on historical incident data and/or a current system status, and/or (v) facilitating the performance, addition, modification, removal, monitoring, securing, etc. of any process, data, software, hardware, etc. to any portion of the distributed system.

To provide the above noted functionality, the system may include management system 100, and/or data processing systems 104. Each of these components is discussed below.

Data processing systems 104 may include any number of data processing systems (e.g., 104A-104N). The any number of data processing systems may host an entity. The entity may include (i) a user, (ii) an administrator, and/or (iii) any other stakeholder of the distributed system. The entity may generate a data request for information. The data request may be received by the any number of data processing systems (e.g., 104A-104N).

The any number of data processing systems (e.g., 104A-104N) and/or management system 100 may store request templates and/or graph data structures in any number of databases, repositories, and/or any other storage systems. The any number of data processing systems (e.g., 104A-104N) may (i) store, (ii) utilize, and/or (iii) update word-embedding models (e.g., (i) Word2Vec, (ii) GloVe (Global Vectors), (iii) BERT (Bidirectional Encoder Representation Transformers), and/or (iv) any other transformer model) for generation of embeddings from tokens in request templates.

The any number of data processing systems (e.g., 104A-104N) and/or management system 100 may (i) store, (ii) utilize, and/or (iii) update at least one first machine learning model that is adapted to recognize relationships between the tokens. The any number of data processing systems (e.g., 104A-104N) may also (i) store, (ii) utilize, and/or (iii) update at least one second machine learning model (i.e., a graph neural network (e.g., (a) a graph convolution network, (b) a graph attention network, (c) message passing neural network, (d) graph recurrent neural network, and/or (e) any other graph neural network) that is adapted to update embeddings.

The any number of data processing systems (e.g., 104A-104N) and/or management system 100 may also utilize information extraction frameworks to utilize sub-graphs of graph data structures to generate an information request. Examples of the information extraction frameworks may include (i) Structured Query Language (SQL), (ii) NoSQL, (iii) ORM (Object Related Mapping) Frameworks, (iv) Apache Hive, (v) ELK (Elasticsearch, Logstash, Kibana) Search, etc.

The information request may be processed by the any number of data processing systems (e.g., 104A-104N). By processing the information request, the any number of data processing systems (e.g., 104A-104N) may facilitate provisioning of desired computer implemented services.

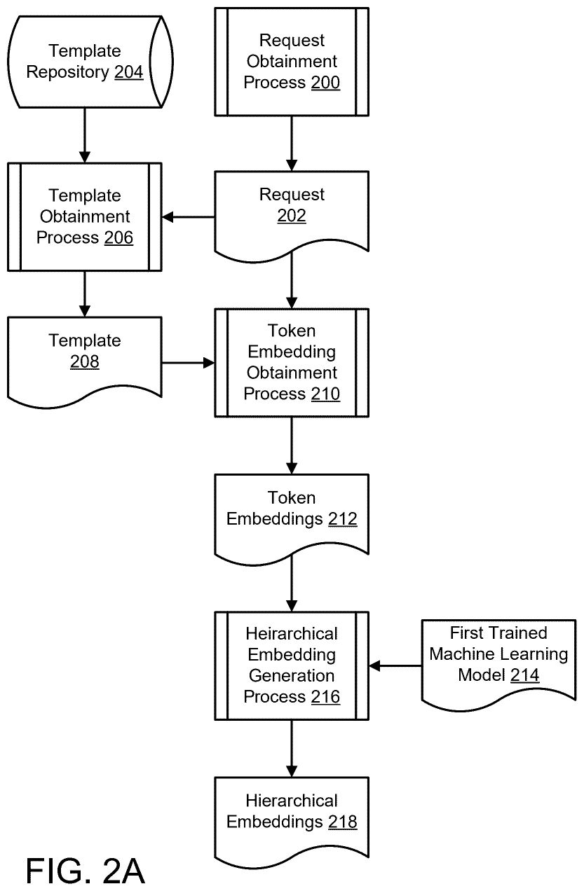

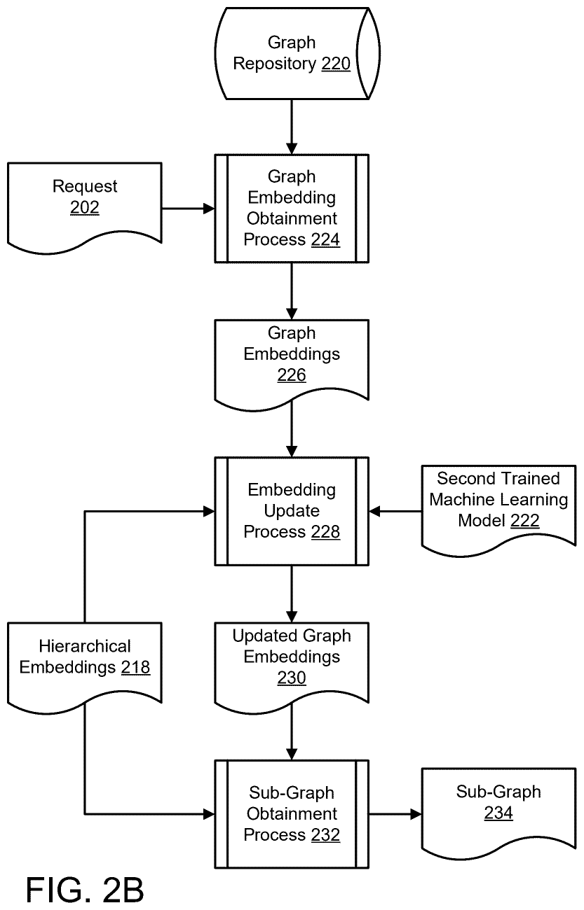

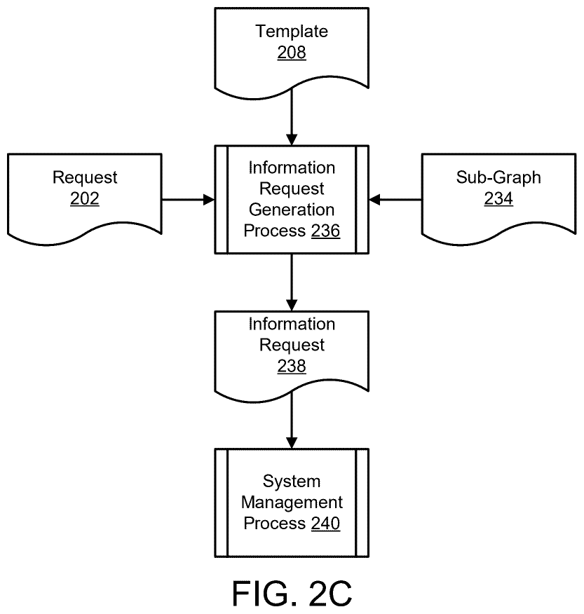

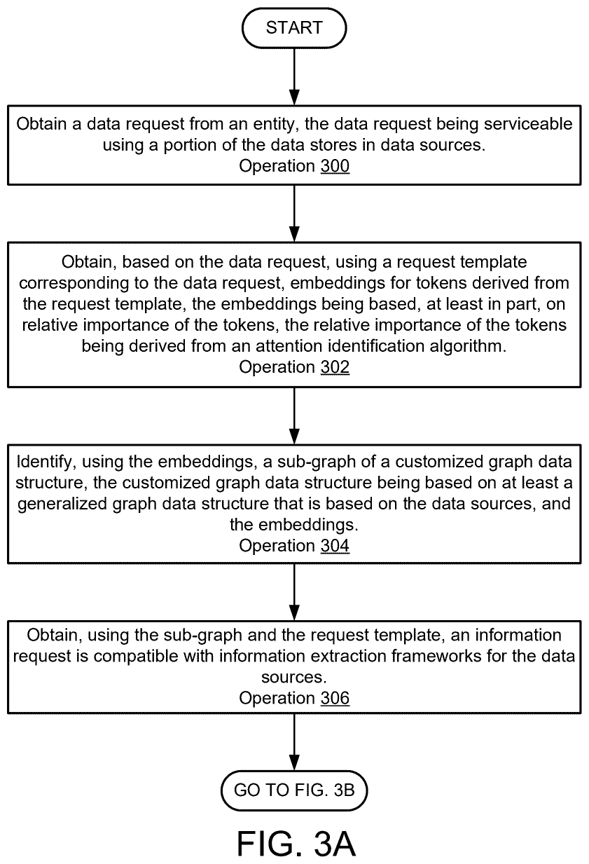

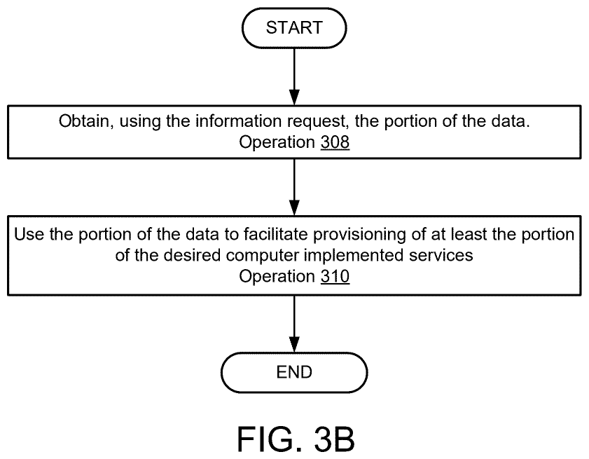

While providing their functionality, any of management system 100 and data processing systems 104 may perform all, or a portion, of the flows and methods shown in FIGS. 2A-3B.

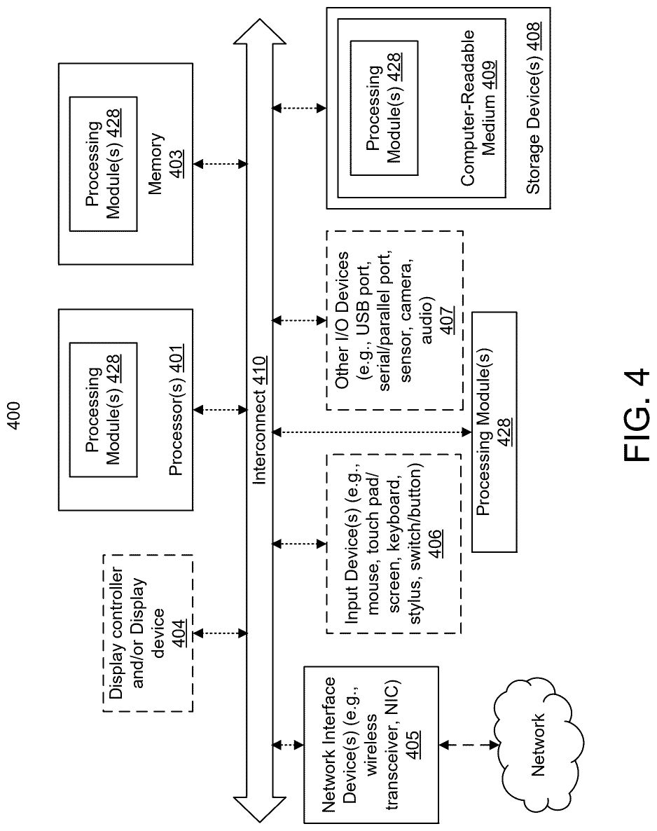

Any of (and/or components thereof) management system 100 and data processing system 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those components illustrated therein.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 202, 208, etc.) is used to represent data structures, a second set of shapes (e.g., 200, 206, etc.) is used to represent processes performed using and/or that generate data, and a third set of shapes (e.g., 204, 220, etc.) is used to represent large scale data structures such as databases.

Turning to FIG. 2A, a first data flow diagram in accordance with an embodiment is shown. The first data flow diagram may illustrate data used in and data processing performed in generating hierarchical embeddings.

To generate the hierarchical embeddings (e.g., 218), a request obtainment process (e.g., 200) may be performed. During the request obtainment process (e.g., 200), a user input may be obtained and/or ingested to generate a request (e.g., 202). The user input may include a generic request and/or an unstructured request for services and/or data. The user input may include, for example, a statement such as “retrieve any personal identifiable information of employees hired in the last year”, “provide the locations of the delivery vans,” “can you provide energy consumption information on all data processing systems?”

During the request obtainment process (e.g., 230), the user input may be ingested, for example, by a trained generative machine learning model (e.g., a large language model, a small language model, and/or any other natural language processing models, etc.) to generate the request (e.g., 202). The trained generative machine learning model may be adapted to generate a structured request, including the request (e.g., 202), for the services.

The request (e.g., 202) may include a structured request. The structured request may include (i) a text data file, (ii) a hierarchical data file, (iii) a command data file, etc. that includes (i) an first identification of a user that submitted the request, (ii) a timestamp, (iii) a criticality level (e.g., low, medium, high, severe), (iv) a second identification of at least one data processing system on which the data request and/or a service using the data request is performed, (v) classifications of data needed to perform the service, (vi) metadata, tags, keywords, statements, etc. with which are used to find associated data needed to perform the services, (vii) any other content associated with the request (e.g., 202).

The request (e.g., 202) may be ingested by a template obtainment process (e.g., 206). During the template obtainment process (e.g., 206), a first search may be performed in a template repository (e.g., 204) to obtain a template (e.g., 208).

The template repository (e.g., 204) may include a repository for storing query templates and/or script templates used by information extractions frameworks. The query templates and/or the script templates may be used by the information extraction frameworks to perform (i) database initialization, (ii) data manipulation, (iii) indexing, (iv) performance tuning, (v) creating and/or managing user roles, and/or (vi) any other operation that can be performed using any data of data sources of the distributed system by the information extraction frameworks.

During the template obtainment process (e.g., 206), a first portion of the request (e.g., 202) may be used to facilitate the first search for a template (e.g., 208) from the template repository (e.g., 204). The first portion may include (i) a data type (e.g., (a) sales data, (b) geodetic data, (c) user history data, and/or (d) any other data type) of the data, (ii) an operation (e.g., (a) selection, (b) insertion, (c) updating, (d) deletion, and/or (e) any other operation that can be performed by the information extraction frameworks), (iii) any relationships and/or joins between a first data and/or a second data of the data, etc. The first search may include ingestion of the first portion of the request (e.g., 202) in (i) a keyword search, (ii) a metadata search, (iii) a machine-learning based search, (iv) a query-building, (v) a query-matching search, (vi) an API-facilitated search, and/or (vii) any other type of search.

The template (e.g., 208) may include at least one of the query templates and/or at least one of the selected script templates. The query templates and/or the script templates may include placeholders which can be replaced with data source identifiers of the data. The data source identifiers may include any reference to the data and/or any portion of the data used to obtain content of the data. Upon replacement of the placeholders with the data source identifiers, each statement and/or each clause of the template (e.g., 208) may be runnable by the information extraction frameworks to service the request (e.g., 202).

To replace the placeholders of the template (e.g., 208), token embedding obtainment process (e.g., 210) may be performed. During the token embedding obtainment process (e.g., 210), the statements and/or the clauses of the template (e.g., 208) may be segmented into at least one array of words. The statements and/or the clauses may be segmented, for example, by (i) obtaining a first one-dimensional array that is empty, (ii) obtaining a two-dimensional array that is empty, (iii) obtaining a first statement and/or first clause with first words, (iii) inserting each word of the words from the first statement and/or the first clause into the first one-dimensional array, in which the each word is assigned a one-dimensional index of the first one-dimensional array, (iv) inserting the first one-dimensional array into the two-dimensional array, in which the first one-dimensional array is assigned a first two-dimensional index, and/or (v) repeating the segmentation and/or the insertion using at least a second statement and/or second clause with second words and/or a second one-dimensional array.

The at least one array of the words may be obtained for each of the statements and/or the clauses. Types of the words may include (i) table names, (ii) field names, (iii) placeholders, (iv) operation words (e.g., (a) “select,” (b) “insert,” (c) “insert,” (d) “delete,” and/or (e) any other operation words), (v) relationship words (e.g., (a) “join,” (b) “inner join,” (c) “left join,” (d) “right join,” and/or (e) any other relationship words), (vi) symbols, etc.

The at least one array of the words in the two-dimensional array may be transformed into token embeddings (e.g., 212). The at least one array of the words may be transformed by ingesting, by a word-embedding model, the at least one word array to generate the token embeddings (e.g., 212). The word embedding model may include a transformer model (e.g., (i) Word2Vec, (ii) GloVe (Global Vectors), (iii) BERT (Bidirectional Encoder Representation Transformers), and/or (iv) any other transformer model).

The token embeddings (e.g., 212) may include at least one first embedding (e.g., a first n-dimensional vector and/or any other first numerical representation) corresponding to the words of the at least one word array. To associate a word of the words of the statements and/or the clauses, for example, an array of key-and/or-value pairs may be used. The values may include the token embeddings (e.g., 212) and/or the keys may include (a) a word associated with a token embedding value, (b) a two-dimensional index of the two-dimensional array of the words associated with the token embedding value, etc.

The token embeddings (e.g., 212) may be ingested in a hierarchical embedding generation process (e.g., 216) to generate hierarchical embeddings (e.g., 218). During the hierarchical embedding generation process (e.g., 216), attention scores between the words may be computed. The attention scores may provide a measure of importance between at least two words of the statements and/or the clauses.

To compute the attention scores, a first trained machine learning model (e.g., 214) may ingest the token embeddings (e.g., 212) to compute the attention scores. The first trained machine learning model may be adapted to compute the attention scores using a first machine learning algorithm. The first machine learning algorithm may include rules and/or procedures for processing the types of the words on which the token embeddings (e.g., 212) are based.

The attention scores may be computed, using the first trained machine learning model, by ingesting at least two first token embeddings of a first statement and/or a first clause into the first machine learning algorithm to generate first attention scores between first words of the first statement and/or the first clause. Next, the at least one first token embedding of the first statement and/or the first clause and/or at least one second token embedding of a second statement and/or the second clause may be ingested by the first machine learning model to generate second attention scores between the first words and/or second words of the second statement and/or the second clause. The first attention scores and/or the second attention scores may be aggregated by the trained machine learning model to generate third attention scores. The third attention scores may use any combination of mathematical operations to balance first contributions of the first attention scores and/or second contributions of the second attentions scores in the third attention scores.

Finally, the third attention scores may be combined with the token embeddings using a combination method (e.g., (i) vector addition, (ii) vector subtraction, (iii) cross product, (iv) element-wise multiplication, (v) concatenation, and/or (vi) any other combination method). Further, the any other combination method may include (i) scaling the third attention scores, (ii) applying an activator function to create a probability distribution and/or (iii) performing a weighted sum of the probability distribution to generate the hierarchical embeddings (e.g., 218).

The hierarchical embeddings (e.g., 218) may include the token embeddings (e.g., 212) that have been updated based on the third attention scores. Thus, the hierarchical embeddings (e.g., 218) include the measures of the importance of the words of the template (e.g., 208) based on definitions of the words from the information extraction frameworks. As a result, the hierarchical embeddings (e.g., 218) may be used for (i) enhanced contextual understanding of relationships and/or dependencies between portions of the template (e.g., 208), (ii) enhanced parsing of the template (e.g., 208) as a result of including the relationships and/or the dependencies, and/or (iii) prioritization of any portion of the template (e.g., 208) to improve performance of meeting at least one requirement of the request (e.g., 202).

Thus, via the first data flow diagram illustrated in FIG. 2A, a system in accordance with an embodiment may generate the hierarchical embeddings (e.g., 218). Consequently, a distributed system may be more likely to be able to provide desired computer implemented services by generating a class of embeddings that can be used to further enhance an obtainment of the data from the data source to meet at least one requirement of the request (e.g., 202).

Turning to FIG. 2B, a second data flow diagram in accordance with an embodiment is shown. The second data flow diagram may illustrate data used in and data processing performed in obtaining a sub-graph of a graph data structure that is relevant to a data source of the distributed system.

To obtain the sub-graph (e.g., 234), a graph embedding process (e.g., 224) may be performed. During the graph embedding process (e.g., 224), (i) a first search may be performed for a first graph data structure and/or (ii) graph embeddings (e.g., 226) may be obtained based on the first graph data structure. The first search may be performed using a request (e.g., 202). The first search may include (i) a keyword search, (ii) a metadata search, (iii) a semantic search, etc. using any first portion of the request (e.g., 202) to obtain the first graph data structure that is most relevant to the request (e.g., 202). The first graph data structure may include sufficient measure of relevancy to the request (e.g., 202) because the first graph data structure includes first nodes corresponding to the sufficient measure of relevant data sources.

The graph embeddings (e.g., 226) may be obtained from the first nodes, which include the graph embeddings (e.g., 226) as metadata of the first nodes. Also, the graph embeddings (e.g., 226) may be obtained from the first nodes by obtaining the graph embeddings from the first nodes. The graph embedding may also be derived by aggregating and/or updating the generalized embeddings based on neighboring nodes of each node of the first graph data structure.

The graph embeddings (e.g., 226) may include at least one second embedding (e.g., a second n-dimensional vector and/or any other second numerical representation) based on the first nodes of the first graph data structure. The first nodes may be based on data sources of the distributed system and/or the edges between the nodes that are based on relationships between the data sources. The data sources associated with the graph embeddings (e.g., 226) may be relevant to the request (e.g., 202) because at least one requirement of the request may be met using the data sources.

Using the graph embeddings (e.g., 226) and/or hierarchical embeddings (e.g., 218), embedding update process (e.g., 228) may be performed. The hierarchical embeddings (e.g., 218) were described in the description of FIG. 2A. During the embedding update process (e.g., 228), the graph embeddings (e.g., 226) may be updated using the hierarchical embeddings to generate updated graph embeddings (e.g., 230).

The graph embeddings (e.g., 226) may be updated, using the second trained machine learning model (e.g., 222), by (i) generating messages based on a first least one neighboring embedding of the graph embeddings (e.g., 226) and/or a second at least one neighboring embedding of the hierarchical embeddings (e.g., 218), (ii) updating a graph embedding of the graph embeddings (e.g., 226) based on the messages to generate an updated graph embedding of the updated graph embeddings (e.g., 230), and/or (iii) repeating the previous two steps for all other graph embeddings (e.g., 226) to generate the updated graph embeddings (e.g., 230). The messages may include (i) framework statements, (ii) data source attributes (e.g., (a) data source names, (b) fields, (c) column names, and/or (d) any other data source attribute), (iii) first relationships between data sources, (iv) second relationships within data sources, etc. The second trained machine learning model may include a graph neural network (e.g., (a) a graph convolution network, (b) a graph attention network, (c) message passing neural network, (d) graph recurrent neural network, and/or I any other graph neural network) that is adapted to update the generalized embeddings to generate the customized embeddings.

The updated graph embeddings (e.g., 230) may include at least one third embedding (e.g., a third n-dimensional vector and/or any other third numerical representation). The at least one third embedding may be based on contextual information regarding (i) the data sources on which the graph embeddings (e.g., 226) are based, (ii) the words of the template (e.g., 208) based on definitions of the words from the information extraction frameworks, and/or (iii) the measures of importance between the words. As a result, the at least one third embedding may include third representations of properties and/or relationships between (i) the data sources, (ii) the words, and/or (iii) the measures of importance between the words.

The updated graph embeddings (e.g., 230) may be used to perform a sub-graph obtainment process (e.g., 232). During the sub-graph obtainment process (e.g., 232), the updated graph embeddings (e.g., 230) may be used to obtain the sub-graph (e.g., 234) of a second graph data structure on which the updated graph embeddings (e.g., 230) are based.

The sub-graph (e.g., 234) may be obtained by (i) performing first similarity computations between at least the hierarchical embeddings (e.g., 218) and/or the updated graph embeddings (e.g., 230) to generate the second graph data structure, (ii) rank-ordering nodes of the second graph data structure based on first similarity scores of the first similarity computations, and/or (iii) extracting second nodes and/or second edges from the second graph data structure based on the rank-ordered nodes having the first similarity scores that exceed a first similarity threshold score.

The similarity computations may include computations of (i) a cosine similarity, (ii) a Euclidean distance, (iii) a Jaccard similarity, (iv) a Manhattan distance, (v) a Minkowski Distance, and/or (vi) any other distance. Similarity scores of the similarity computations may include different ranges based on the similarity computations. In a first example, a cosine similarity score includes a single integer bounded and/or including 0.0 and/or 1.0. The cosine similarity score further includes a measure of an angle between two vectors of the numerical representations. A first score of 1.0 includes perfect similarity between the two vectors and/or a second score of 0.0 includes no similarity between the two vectors. In a second example, a Euclidean distance also includes the single integer bounded and/or including 0.0 and/or infinity. The Euclidean distance further includes a straight line distance between two points in multi-dimensional space. The two points may be obtained from the two vectors of the numerical representations. A low value for the Euclidean distance may include high similarity between the two vectors and/or a high value for the Euclidean distance may include low similarity between the two vectors.

Thus, the sub-graph (e.g., 234) may include a portion of the second graph data structure. The sub-graph may also include the portion of the second nodes and/or the second edges that includes the relevant data sources for the request (e.g., 202). The relevant data sources may be used to obtain data source identifiers that may be used to replace placeholders of a template (e.g., 208 from FIG. 2A) to generate a serviceable query template.

Thus, via the second data flow diagram illustrated in FIG. 2B, a system in accordance with an embodiment may obtain the sub-graph (e.g., 234). Consequently, a distributed system may be more likely to be able to provide desired computer implemented services by identifying the sub-graph (e.g., 234) that includes the relevant data sources for the request (e.g., 202).

Turning to FIG. 2C, a third data flow diagram in accordance with an embodiment is shown. The third data flow diagram may illustrate data used in and data processing performed in servicing an information request.

To service the information request (e.g., 238), an information request generation process (e.g., 236) may be performed. During the information request generation process (e.g., 236), a request (e.g., 202) for data, a template (e.g., 208) and/or a sub-graph (e.g., 234) may be used to generate the information request (e.g., 238). The request (e.g., 238) and the template (e.g., 208) are described in the description of FIG. 2A. The sub-graph (e.g., 234) is also described in the description of FIG. 2B.

To generate the information request (e.g., 238), (i) placeholders of the template (e.g., 208) may be identified, (ii) data sources to meet at least one requirement of the request (e.g., 202) may be identified in at least one node of the sub-graph (e.g., 234), (iii) data source identifiers for the placeholders may be obtained from the at least one node may be identified, and/or (iv) the placeholders may be replaced by the data source identifiers to generate the information request (e.g., 238). The data sources may be identified by (i) identifying a first node of the sub-graph (e.g., 234) with data related to the request (e.g., 202) and/or (ii) performing a trace from the first node to a second node using a first edge to identify other data sources in the sub-graph (e.g., 234). The data source identifiers may be obtained by extracting any portion of data of the data source (e.g., (a) a column name, (b) a field name, (c) a data type, and/or (d) any other portion of the data).

The information request (e.g., 238) may include the template (e.g., 208) with the placeholders that have been replaced with the data source identifiers. As a result, the information request (e.g., 238) may include a query template that can be ingested and/or processed by an information extraction framework to retrieve information from the distributed system.

Using the information request (e.g., 238), a system management process (e.g., 240) may be performed. During the system management process (e.g., 240), the information may be retrieved using the information request (e.g., 238) by transmitting the information request (e.g., 238) to the information extraction frameworks to (i) filter, (ii) prioritize, and/or (iii) retrieve the information. The information may include relevant data for use in the provisioning of the desired computer implemented services.

The information may be used to facilitate provisioning at least a portion of the desired computer implemented services by (i) facilitating performance of optimization actions based on, for example, performance metrics, (ii) adding security patches and/or configurations based on vulnerabilities and/or threat patterns, (iii) adding, modifying, and/or removing access rights based on roles and/or historical usage, (iv) facilitating the performance of incident response actions based on historical incident data and/or a current system status, and/or (v) facilitating the performance, addition, modification, removal, monitoring, securing, etc. of any process, data, software, hardware, etc. to any portion of the distributed system.

Thus, via the third data flow diagram illustrated in FIG. 2C, a system in accordance with an embodiment may service the information request (e.g., 238). Consequently, a distributed system may be more likely to be able to provide desired computer implemented services by generating, using at least the sub-graph (e.g., 234), an information request (e.g., 238) for retrieval of the information used to facilitate a provisioning of desired computer implemented services.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to providing desired computer implemented services using data stored in data sources of a distributed system. FIGS. 3A-3B illustrate a method that may be performed by the components of the system of FIG. 1. In the diagram discussed below and shown in FIGS. 3A-3B, any of the operations may be repeated, performed in different orders, and/or performed in parallel with or in a partially overlapping in time manner with other operations.

Turning to FIG. 3A, a flow diagram illustrating a method of providing the desired computer implemented services using the data stored in the data sources of the distributed system in accordance with an embodiment is shown. The method may be performed, for example, by any of the components of the system of FIG. 1, and/or other components not shown therein.

At operation 300, a data request may be obtained from an entity, the data request being serviceable using a portion of the data stores in data sources. The data request may be obtained by receiving, by the distributed system and/or from the entity, the data request for information. The entity may include (i) a user, (ii) an administrator, and/or (iii) any other stakeholder of the distributed system. The information may include (i) performance data of the distributed system, (ii) traffic data of the distributed system, (iii) inventory data of items tracked by software of the distributed system, (iv) sales statistics in a database of the distributed system, etc.

At operation 302, embeddings for tokens derived from the request template may be obtained, using a request template corresponding to the data request, the embeddings being based, at least in part, on relative importance of the tokens, the relative importance of the tokens being derived from an attention identification algorithm. The embeddings may be obtained by (i) generating the embeddings for the tokens, the embeddings comprising first numerical representations of the tokens that are not initially based on the relative importance of the tokens, (ii) computing, using the attention identification algorithm, first attention scores between a first token of the tokens and a second token of the tokens in first statement of the statements of the request template, (iii) computing, using the attention identification algorithm, second attention scores between the first token of the tokens in the first statement and a third token of the tokens in a second statement of the request template, (iv) generating third attention scores that are based on the first attention scores and the second attention scores by performing at least one mathematical operation using the first attention scores and the second attention scores, and (v) updating, using the third attention scores, the embeddings comprising second numerical representations that are based, at least in part, on the relative importance of the tokens and the first numerical representations.

The embeddings may be generated by ingesting the tokens in a word embedding model (e.g., (i) Word2Vec, (ii) GloVe (Global Vectors), (iii) BERT (Bidirectional Encoder Representation Transformers), and/or (iv) any other transformer model) to transform the tokens into the embeddings. The first attention scores may be computed by ingesting a first token embedding of a first statement of the request template and/or a second embedding of the first statement of the request template in a first trained machine learning model that includes the attention identification algorithm. The first attention scores may include first measures of relative importance between the first token embedding and/or the second token embedding. The second attention scores may be computed by ingesting the first token embedding of the first statement of the request template and/or a third embedding of a second statement of the request template in the first trained machine learning model. The second attention scores may include second measures of relative importance between the first token embedding and/or the third token embedding. The third attention scores may be generated by combining the first attention scores and/or the second attention scores using at least one mathematical operation. The embeddings may be updated using the third attention scores by using a combination method (e.g., (i) vector addition, (ii) vector subtraction, (iii) cross product, (iv) element-wise multiplication, (v) concatenation, and/or (vi) any other combination method). Further, the any other combination method may include (i) scaling the third attention scores, (ii) applying an activator function to create a probability distribution and/or (iii) performing a weighted sum of the probability distribution to generate the embeddings.

At operation 304, a sub-graph of a customized graph data structure may be identified using the embeddings, the customized graph data structure being based on at least (i) a generalized graph data structure that is based on the data sources, and (ii) the embeddings. The sub-graph may be identified by (i) identifying the generalized graph data structure that is based on at least one data source related to the data request, (ii) obtaining generalized embeddings from first nodes and first edges of the generalized graph data structure, (iii) updating, using the embeddings, the generalized embeddings to generate customized embeddings, and/or (iv) identifying, using the customized embeddings, the sub-graph.

The generalized graph data structure may be identified by performing a search for the generalized graph data structure that is most relevant to the data request. The generalized embeddings may be obtained by extracting the generalized embeddings from the first nodes and/or deriving the generalized embedding using the first nodes and/or the first edges. The customized embeddings may be generated, using a second trained machine learning model, by generating messages based on a first least one neighboring embedding of the generalized embeddings and/or a second at least one neighboring embedding of the embeddings, (ii) updating a generalized embedding based on the messages to generate a customized embedding, and/or (iii) iterating the previous two steps for all other generalized embeddings to generate the customized embeddings. The messages may include (i) framework statements, (ii) data source attributes (e.g., (a) data source names, (b) fields, (c) column names, and/or (d) any other data source attribute), (iii) first relationships between data sources, (iv) second relationships within data sources, etc. The second trained machine learning model may include a graph neural network (e.g., (a) a graph convolution network, (b) a graph attention network, (c) message passing neural network, (d) graph recurrent neural network, and/or (e) any other graph neural network) that is adapted to update the generalized embeddings to generate the customized embeddings. The sub-graph may be identified by performing similarity computations between the customized embeddings and/or the embeddings to obtain second nodes and second edges of the customized graph data structure. The similarity computations may be performed by (i) generating similarity scores between the embeddings and/or the customized embeddings, (ii) rank-ordering the similarity scores, (iii) comparing the similarity scores to a similarity score threshold, and/or (iv) extracting second nodes and/or second edges that are associated with the similarity scores that exceed the similarity score threshold.

At operation 306, an information request may be obtained, using the sub-graph and the request template, that is compatible with information extraction frameworks for the data sources. The information request may be obtained by (i) identifying, using the data request and the sub-graph, data source identifiers related to the data request using the data sources of the sub-graph, and/or (ii) generating, using the data source identifiers and the request template, the information request by replacing at least one placeholder of the placeholders with at least one data source identifier of the data source identifiers.

The data source identifiers may be identified by (i) performing a trace from the third node of the sub-graph to the fourth node of the sub-graph using a first edge between the third node and/or the fourth node and/or (ii) extracting the data source identifiers from the third node and/or the fourth node. The information request may be generated by replacing a placeholder of the placeholders with a data source identifier of the data source identifiers.

Continuing in FIG. 3B, at operation 308, the portion of the data may be obtained using the information request. The portion of the data may be obtained by transmitting the information request (e.g., 238) to the information extraction frameworks to (i) filter, (ii) prioritize, and/or (iii) retrieve the information. The information may include relevant data for use in the provisioning of the desired computer implemented services.

At operation 310, the portion of the data may be used to facilitate provisioning of at least the portion of the desired computer implemented services. The portion of the data may be used by (i) facilitating performance of optimization actions based on, for example, performance metrics, (ii) adding security patches and/or configurations based on vulnerabilities and/or threat patterns, (iii) adding, modifying, and/or removing access rights based on roles and/or historical usage, (iv) facilitating the performance of incident response actions based on historical incident data and/or a current system status, and/or (v) facilitating the performance, addition, modification, removal, monitoring, securing, etc. of any process, data, software, hardware, etc. to any portion of the distributed system.

The method may end following operation 310.

Thus, via the method shown in FIGS. 3A-3B, embodiments herein may likely improve a likelihood of providing the desired computer implemented services using the data stored in the data sources of the distributed system. By improving the likelihood of providing the desired computer implemented services using the data stored in the data sources of the distributed system, the distributed system may be more likely to provide desirable computer implemented services by, for example, customizing embeddings of a generalized graph data structure based on a data request to generate the customized embeddings, using the customized embeddings to generate a sub-graph, using the sub-graph for identification of data source identifiers for a retrieval of information, etc.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing desired computer implemented services using data stored in data sources of a distributed system, the method comprising:
obtaining a data request from an entity, the data request being serviceable using a portion of the data stores in data sources;
based on the data request:
obtaining, using a request template corresponding to the data request, embeddings for tokens derived from the request template, the embeddings being based, at least in part, on relative importance of the tokens, the relative importance of the tokens being derived from an attention identification algorithm;
identifying, using the embeddings, a sub-graph of a customized graph data structure, the customized graph data structure being based on at least:
a generalized graph data structure that is based on the data sources, and the embeddings;
obtaining, using the sub-graph and the request template, an information request is compatible with information extraction frameworks for the data sources;
obtaining, using the information request, the portion of the data; and
using the portion of the data to facilitate provisioning of at least the portion of the desired computer implemented services.

2. The method of claim 1, wherein the request template is a query template that comprises prototype clauses having placeholders for input therein, the prototype clauses being runnable clauses after replacement of the placeholders with the input.

3. The method of claim 2, wherein obtaining the information request comprises:
identifying, using the data request and the sub-graph, data source identifiers related to the data request using the data sources of the sub-graph; and
generating, using the data source identifiers and the request template, the information request by replacing at least one placeholder of the placeholders with at least one data source identifier of the data source identifiers.

4. The method of claim 1, wherein the tokens are clauses from the request template.

5. The method of claim 4, wherein the tokens are based on a tokenization schema that defines a division of the request template based on the clauses into the tokens.

6. The method of claim 4, wherein obtaining the embeddings comprises:
generating the embeddings for the tokens, the embeddings comprising first numerical representations of the tokens that are not initially based on the relative importance of the tokens;
computing, using the attention identification algorithm, first attention scores between a first token of the tokens and a second token of the tokens in first statement of the clauses of the request template;
computing, using the attention identification algorithm, second attention scores between the first token of the tokens in the first statement and a third token of the tokens in a second statement of the request template;
generating third attention scores that are based on the first attention scores and the second attention scores by performing at least one mathematical operation using the first attention scores and the second attention scores; and
updating, using the third attention scores, the embeddings comprising second numerical representations that are based, at least in part, on the relative importance of the tokens and the first numerical representations.

7. The method of claim 1, wherein the generalized graph data structure comprises nodes corresponding to the data sources and edges between the nodes corresponding to relationships between the nodes.

8. The method of claim 7, wherein the information extraction frameworks are database architectures that are adapted to provide information based on the information request, the database architectures having an execution engine that is adapted to interpret, at least, clauses from the information request and provide information based on the interpretation.

9. The method of claim 1, wherein identifying the sub-graph comprises:
identifying the generalized graph data structure that is based on at least one data source related to the data request;
obtaining generalized embeddings from first nodes and first edges of the generalized graph data structure;
updating, using the embeddings, the generalized embeddings to generate customized embeddings; and
identifying, using the customized embeddings, the sub-graph.

10. The method of claim 1, wherein the information request is a query usable to obtain the portion of the data.

11. The method of claim 9, wherein identifying the sub-graph further comprises:
performing similarity computations between the customized embeddings and the embeddings to obtain second nodes and second edges of the customized graph data structure.

12. A non-transitory machine-readable medium having instructions stored therein, which when executed by a processor, cause the processor to perform operations for providing desired computer implemented services using data stored in data sources of a distributed system, the operations comprising:
obtaining a data request from an entity, the data request being serviceable using a portion of the data stores in data sources;
based on the data request:
obtaining, using a request template corresponding to the data request, embeddings for tokens derived from the request template, the embeddings being based, at least in part, on relative importance of the tokens, the relative importance of the tokens being derived from an attention identification algorithm;
identifying, using the embeddings, a sub-graph of a customized graph data structure, the customized graph data structure being based on at least:
a generalized graph data structure that is based on the data sources, and the embeddings;
obtaining, using the sub-graph and the request template, an information request is compatible with information extraction frameworks for the data sources;
obtaining, using the information request, the portion of the data; and
using the portion of the data to facilitate provisioning of at least the portion of the desired computer implemented services.

13. The non-transitory machine-readable medium of claim 12, wherein the request template is a query template that comprises prototype clauses having placeholders for input therein, the prototype clauses being runnable clauses after replacement of the placeholders with the input.

14. The non-transitory machine-readable medium of claim 13, wherein obtaining the information request comprises:
identifying, using the data request and the sub-graph, data source identifiers related to the data request using the data sources of the sub-graph; and
generating, using the data source identifiers and the request template, the information request by replacing at least one placeholder of the placeholders with at least one data source identifier of the data source identifiers.

15. The non-transitory machine-readable medium of claim 12, wherein the tokens are clauses from the request template.

16. The non-transitory machine-readable medium of claim 15, wherein the tokens are based on a tokenization schema that defines a division of the request template based on the clauses into the tokens.

17. A data processing system, comprising:
a processor; and
a memory coupled to the processor to store instructions, which when executed by the processor, cause the processor to perform operations providing desired computer implemented services using data stored in data sources of a distributed system, the operations comprising:
obtaining a data request from an entity, the data request being serviceable using a portion of the data stores in data sources;
based on the data request:
obtaining, using a request template corresponding to the data request, embeddings for tokens derived from the request template, the embeddings being based, at least in part, on relative importance of the tokens, the relative importance of the tokens being derived from an attention identification algorithm;
identifying, using the embeddings, a sub-graph of a customized graph data structure, the customized graph data structure being based on at least:
a generalized graph data structure that is based on the data sources, and
the embeddings;
obtaining, using the sub-graph and the request template, an information request is compatible with information extraction frameworks for the data sources;
obtaining, using the information request, the portion of the data; and
using the portion of the data to facilitate provisioning of at least the portion of the desired computer implemented services.

18. The data processing system of claim 17, wherein the request template is a query template that comprises prototype clauses having placeholders for input therein, the prototype clauses being runnable clauses after replacement of the placeholders with the input.

19. The data processing system of claim 18, wherein obtaining the information request comprises:
identifying, using the data request and the sub-graph, data source identifiers related to the data request using the data sources of the sub-graph; and
generating, using the data source identifiers and the request template, the information request by replacing at least one placeholder of the placeholders with at least one data source identifier of the data source identifiers.

20. The data processing system of claim 17, wherein the tokens are clauses from the request template.
